(19) United States
(12) Patent Application Publication
(10) Pub. No.: US 2024/0172803 A1
(43) Pub. Date: May 30, 2024

(54) VAPORIZATION DEVICE

(71) Applicant: VERDEWELL INTERNATIONAL HOLDINGS LIMITED, George Town (KY)

(72) Inventor: Yufeng LIU, Shenzhen (CN)

(21) Appl. No.: 18/512,584

(22) Filed: Nov. 17, 2023

(30) Foreign Application Priority Data
Nov. 30, 2022 (CN) 202223233647.8

(51) Int. Cl. A24F 40/485; A24F 40/10; A24F 40/42

(52) U.S. Cl. CPC A24F 40/485; A24F 40/10; A24F 40/42

(57) ABSTRACT

A vaporization device includes: an upper housing having a liquid injection channel and a connection portion; and a main body including a liquid storage tank configured to store liquid, a locking portion, and a seal member. The upper housing is sleeved on the main body and fixedly connects the locking portion to the connection portion. When the locking portion is fixedly connected to the connection portion and is in a first state, the liquid injection channel is in communication with the liquid storage tank. When the locking portion is fixedly connected to the connection portion and is in a second state, the seal member blocks the liquid injection channel.

### CROSS-REFERENCE TO PRIOR APPLICATION

Priority is claimed to Chinese Patent Application No. 202223233647.8, filed on Nov. 30, 2022, the entire disclosure of which is hereby incorporated by reference herein.

### FIELD

This application relates to the technical field of vaporization apparatuses, and specifically, to a vaporization device.

### BACKGROUND

Currently, during assembly of a vaporization apparatus product, a main body portion where a mouthpiece and an e-liquid storage tank are located are in two independent portions. A liquid needs to be injected into the e-liquid storage tank before the mouthpiece is mounted to the main body portion, and the mouthpiece needs to be fixed to the main body portion with snaps or rivets through press-fit, which is complicated and inconvenient to perform. In addition, the process time after the liquid injection is excessively long. If the mouthpiece is not pressed into seal in time, the liquid may leak out from a ceramic core through a liquid flowing hole.

### SUMMARY

In an embodiment, the present invention provides a vaporization device, comprising: an upper housing comprising a liquid injection channel and a connection portion; and a main body comprising a liquid storage tank configured to store liquid, a locking portion, and a seal member, wherein the upper housing is sleeved on the main body and configured to fixedly connect the locking portion to the connection portion, wherein, when the locking portion is fixedly connected to the connection portion and is in a first state, the liquid injection channel is in communication with the liquid storage tank, and wherein, when the locking portion is fixedly connected to the connection portion and is in a second state, the seal member is configured to block the liquid injection channel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural three-dimensional view of a vaporization device according to an embodiment of this application.

FIG. 2 is a schematic structural cross-sectional view of a vaporization device according to an embodiment of this application.

FIG. 3 is another schematic structural cross-sectional view of a vaporization device according to an embodiment of this application.

FIG. 4 is a schematic diagram of an exploded structure of a vaporization device according to an embodiment of this application.

FIG. 5 is an enlarged structural diagram of I in FIG. 2 according to an embodiment of this application.

FIG. 6 is an enlarged structural diagram of II in FIG. 3 according to an embodiment of this application.

### DETAILED DESCRIPTION

In an embodiment, the present invention provides a vaporization device.

In an embodiment, the vaporization device includes an upper housing and a main body. The upper housing includes a liquid injection channel and a connection portion. The main body includes a liquid storage tank, a locking portion, and a seal member, where the liquid storage tank is configured to store liquid, and the upper housing is sleeved on the main body and configured to fixedly connect the locking portion to the connection portion. When the locking portion is fixedly connected to the connection portion and is in a first state, the liquid injection channel is in communication with the liquid storage tank; and when the locking portion is fixedly connected to the connection portion and is in a second state, the seal member blocks the liquid injection channel.

In an embodiment, the vaporization device includes an upper housing and a main body. The upper housing may be fitted and connected to the main body through a connection portion and a locking portion. When the locking portion and the connection portion are in the first state, the liquid injection channel is in communication with the liquid storage tank, so that the liquid can be injected into the liquid storage tank through the liquid injection channel. After the liquid injection ends, the locking portion and the connection portion are switched to a second state, and the seal member can block the liquid injection channel to prevent the liquid from leaking out from the liquid storage tank. In this way, during assembly, the upper housing and the main body are integrally formed, and the locking portion and the connection portion may perform liquid injection through the liquid injection channel after being in the first state. After the liquid injection is completed, the locking portion and the connection portion are directly controlled to switch to the second state, which is easy to operate, improves operation efficiency, and reduces a risk of poor liquid leakage.

In some embodiments, the locking portion includes a first locking portion and a second locking portion, the first locking portion and the second locking portion are arranged in a length direction of the vaporization device, the connection portion includes a first connection portion and a second connection portion, and the first connection portion and the second connection portion are respectively arranged corresponding to the first locking portion and the second locking portion. When the locking portion and the connection portion are in the first state, the first connection portion is connected to the second locking portion; and when the locking portion and the connection portion are in the second state, the first connection portion is connected to the first locking portion, and the second connection portion is connected to the second locking portion. In this way, the first locking portion and the second locking portion are arranged in a vertical direction, and the first connection portion and the second connection portion are also vertically arranged, so that the two connection portions and the two locking portions may be fixedly connected corresponding to each other, and the upper housing and the main body can realize two connection states. When the first connection portion and the second locking portion are connected to realize the first state, the upper housing and the main body are to be mounted, and the liquid storage tank may be filled with liquid through the liquid injection channel. When the first connection portion is connected to the first locking portion and the second connection portion is connected to the second locking portion to realize the second state, the upper housing and the main body are completely fixed to ensure stability of the fixed connection, and the seal member can block the liquid injection channel to prevent the liquid from leaking out from the liquid storage tank.

In some embodiments, when the first connection portion is connected to the second locking portion, the liquid injection channel and the seal member are spaced apart from each other, and the liquid injection channel is in communication with the liquid storage tank; and when the first connection portion is connected to the first locking portion and the second connection portion is connected to the second locking portion, the seal member partially extends into the liquid injection channel to block the liquid injection channel. In this way, when the first connection portion and the second locking portion are connected to realize the first state, the upper housing and the main body are to be mounted, the seal member and the liquid injection channel are spaced apart from each other, and the liquid storage tank may be filled with liquid through the liquid injection channel. When the first state is switched to the second state, the upper housing and the main body can be close to each other in the vertical direction, so that the first connection portion is connected to the first locking portion and the second connection portion is connected to the second locking portion. Meanwhile, the seal member is close to the upper housing together with the main body, and the seal member may partially extend into the liquid injection channel to block the liquid injection channel.

In some embodiments, the main body includes a shell and a support, the support is arranged inside the shell and connected to the shell, and an accommodating groove is formed between the shell and the support; and the upper housing includes a main body and a connection portion extending from the main body, and the connection portion at least partially extends into the accommodating groove to connect the upper housing to the main body. In this way, the shell can be moved with the support relative to the upper housing at the same time, and the connection portion of the upper housing can extend into the accommodating groove, so that the accommodating groove can limit the position of the connection portion, avoid dislocation of the connection between the upper housing and the main body, and ensure that the connection portion and the locking portion can be stably connected.

In some embodiments, the locking portion is formed on the support, the locking portion is accommodated in the accommodating groove, and the connection portion extends into the accommodating groove to be connected to the locking portion. In this way, during the assembly of the upper housing and the main body, the connection portion can be inserted into the accommodating groove to define positions of the upper housing and the main body. In this case, the locking portion on the support can cooperate with the connection portion, so that the upper housing and the main body realize the first state and the second state.

In some embodiments, a limiting groove is formed on the upper housing, and the shell abuts against the limiting groove when the locking portion and the connection portion are in the second state. In this way, the locking portion and the connection portion are in the second state, the upper housing and the main body are fixedly connected, and the shell may abut against the limiting groove to limit relative positions of the main body and the upper housing, so that the shell and the upper housing can cooperate to protect the internal components of the vaporization device.

In some embodiments, the locking portion includes a protrusion, the connection portion includes a groove, and the protrusion is engaged with the groove to fix the upper housing and the main body. In this way, the protrusions can be engaged with the grooves to fix the relative positions of the upper housing and the main body to ensure that the locking portion and the connection portion can be in the first state and the second state.

In some embodiments, the protrusion includes an inclined surface and an abutting surface, the inclined surface pushes up the upper housing for the protrusion to be engaged with the groove when the upper housing is assembled with the main body, and the abutting surface abuts against the groove to prevent the protrusion from being disengaged from the groove. In this way, during the sliding of the upper housing in a direction close to the main body, the upper housing has elasticity, so that the inclined surface can stretch the upper housing. After the protrusion enters the groove, the abutting surface can abut against an inner wall of the groove to prevent the upper housing and the main body from moving away, so that the locking portion and the connection portion can realize a fixed connection mode of the first state and the second state.

In some embodiments, the seal member is in the shape of a cylinder, the liquid injection channel is in the shape of a circular hole, and the seal member is concentric with the liquid injection channel; and when the locking portion and the connection portion are in the second state, the seal member is in interference fit with the liquid injection channel to block the liquid injection channel. In this way, the seal member is in the shape of a cylinder, the liquid injection channel is in the shape of a circular hole, and the seal member may at least partially extend into the liquid injection channel. The seal member is in interference fit with the liquid injection channel to block the liquid injection channel, so as to prevent the liquid in the liquid storage tank from leaking through the liquid injection channel.

In some embodiments, a chamfer is formed at an end of the seal member, and a seal ring is formed at an end of the liquid injection channel close to the main body; and when the locking portion and the connection portion are in the second state, the end of the seal member extends into the liquid injection channel and is in interference fit with the seal ring for the seal member to block the liquid injection channel. In this way, when the locking portion and the connection portion are switched to the second state, the chamfer can conveniently extend into the liquid injection channel, and at the same time, an edge and corner of the end of the seal member can be avoided to scratch the seal member. The seal ring may be in interference fit with the seal ring to block the liquid injection channel from the inside to prevent the liquid in the liquid storage tank from leaking through the liquid injection channel.

Other aspects and advantages of this application will be given in the following description, some of which will become apparent from the following description or may be learned from practices of this application.

### DESCRIPTION OF MAIN ELEMENT SYMBOLS

Vaporization device 100;

Upper housing 10, Liquid injection channel 11, Seal ring 111, Connection portion 12, First connection portion 121, Second connection portion 122, Limiting groove 13, Main body 20, Liquid storage tank 21, Locking portion 22, First locking portion 221, Second locking portion 222, Inclined surface 223, Abutting surface 224, Seal member 23, Chamfer 231, Shell 24, Support 25, and Accommodating groove 26.

Embodiments of this application are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary and used only for explaining this application, and should not be construed as a limitation on this application.

In this application, unless otherwise explicitly stipulated and restricted, that a first feature is “on” or “under” a second feature may include that the first and second features are in direct contact, or may include that the first and second features are not in direct contact but in contact by using other features therebetween. In addition, that the first feature is “on”, “above”, or “over” the second feature includes that the first feature is right above and on the inclined top of the second feature or merely indicates that a level of the first feature is higher than that of the second feature. That the first feature is “below”. “under”, or “beneath” the second feature includes that the first feature is right below the second feature or at an inclined bottom of the second feature, or may merely indicate that the horizontal position of the first feature is lower than that of the second feature.

Many different embodiments or examples are provided in the following disclosure to implement different structures of this application. To simplify the disclosure of this application, components and settings in particular examples are described below. Certainly, they are merely examples and are not intended to limit this application. In addition, this application may repeat reference numerals and/or reference letters in different examples. The repetition is for purpose of simplification and clarity, but does not indicate a relationship between the various embodiments and/or settings discussed. Moreover, this application provides examples of a plurality of specific processes and materials, but a person of ordinary skill in the art may be aware of application of another process and/or use of another material.

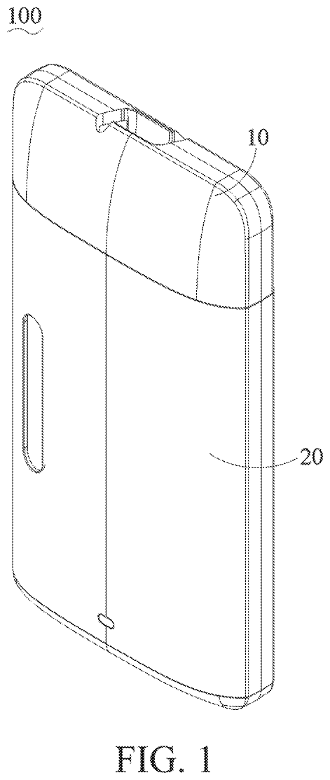

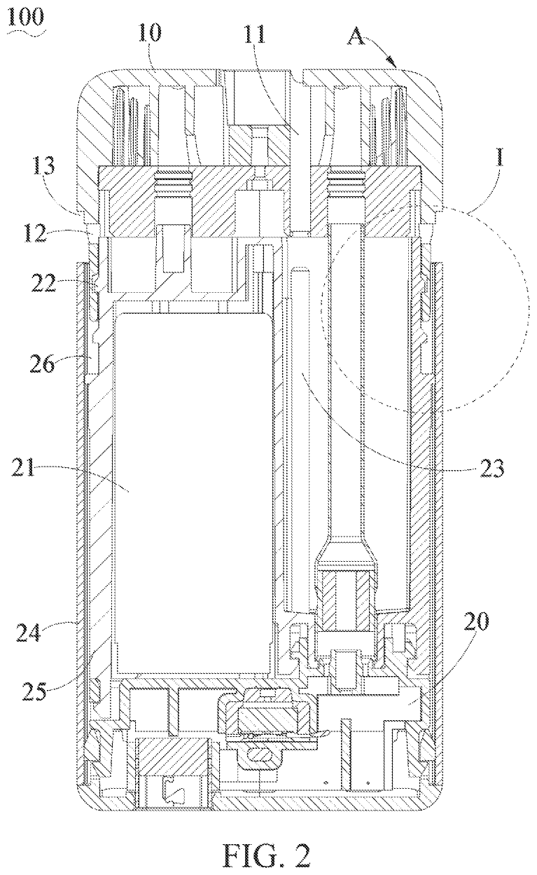

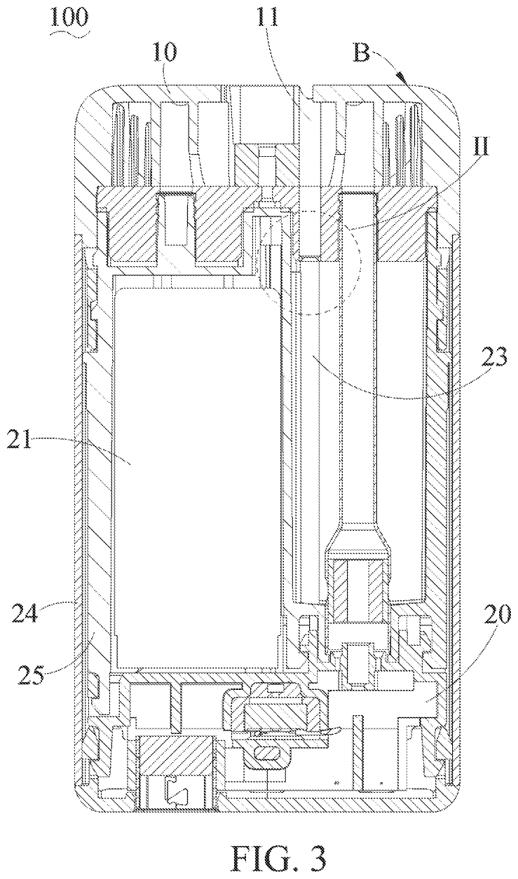

Referring to FIG. 1, FIG. 2, and FIG. 3, the vaporization device 100 in an embodiment of this application includes an upper housing 10 and a main body 20. The upper housing 10 includes a liquid injection channel 11 and a connection portion 12. The main body 20 includes a liquid storage tank 21, a locking portion 22, and a seal member 23. The liquid storage tank 21 is configured to store liquid, and the upper housing 10 is sleeved on the main body 20 and configured to fixedly connect the locking portion 22 and the connection portion 12. When the locking portion 22 is fixedly connected to the connection portion 12 and is in a first state A, the liquid injection channel 11 is in communication with the liquid storage tank 21; and when the locking portion 22 is fixedly connected to the connection portion 12 and is in a second state B, the seal member 23 blocks the liquid injection channel 11.

According to the vaporization device 100 in an embodiment of this application, the vaporization device 100 includes an upper housing 10 and a main body 20. The upper housing 10 may be fitted and connected to the main body 20 through the connection portion 12 and the locking portion 22. When the locking portion 22 and the connection portion 12 are in the first state A, the liquid injection channel 11 is in communication with the liquid storage tank 21, so that the liquid can be injected into the liquid storage tank 21 through the liquid injection channel 11. After the liquid injection ends, the locking portion 22 and the connection portion 12 are switched to the second state B, and the seal member 23 can block the liquid injection channel 11 to prevent the liquid from leaking out from the liquid storage tank 21. In this way, during assembly, the upper housing 10 and the main body 20 are integrally formed, and the locking portion 22 and the connection portion 12 may perform liquid injection through the liquid injection channel 11 after being in the first state A. After the liquid injection is completed, the locking portion 22 and the connection portion 12 are directly controlled to switch to the second state B, which is easy to operate, improves operation efficiency, and reduces a risk of poor liquid leakage.

In the related art, during the assembly of the vaporization device, the assembly of the vaporization device and the liquid injection operation are performed separately. In order to facilitate the liquid injection operation, the upper housing and the main body are required to be completely separated and transported to a position for liquid injection. After the liquid is injected into the liquid storage tank, in order to avoid the process time of liquid injection is excessively long to affect quality of the liquid, the mouthpiece needs to be fixed to the main body with snaps or rivets through press-fit.

In an embodiment of this application, the upper housing 10 and the main body 20 have two connection states. When the locking portion 22 and the connection portion 12 are in the first state A, the upper housing 10 and the main body 20 are in a pre-installed integral form. In this way, the upper housing 10 and the main body 20 can be transported together to the position for liquid injection for the liquid injection, and a cost of transportation and packaging can be reduced. Meanwhile, after the liquid injection is completed, the first state A may be directly switched to the second state B to realize the complete fixation of the upper housing 10 and the main body 20. In this case, the upper housing 10 and the main body 20 cannot switch the state, and a user can perform the liquid injection in other manners.

In some embodiments, after the vaporization device 100 in the embodiment of this application leaves a factory, mutual switch between the second state B and the first state A can also be realized. For example, the upper housing 10 may slide relative to the main body 20 to realize switch between the first state A and the second state B. The user may slide the upper housing 10 in a direction away from the main body 20 to switch to the first state A, so that the liquid injection channel 11 communicates with the liquid storage tank 21, and the user may inject liquid into the liquid storage tank 21. The user may also slide the upper housing 10 in a direction close to the main body 20 to switch to the second state B for daily use of the vaporization device 100.

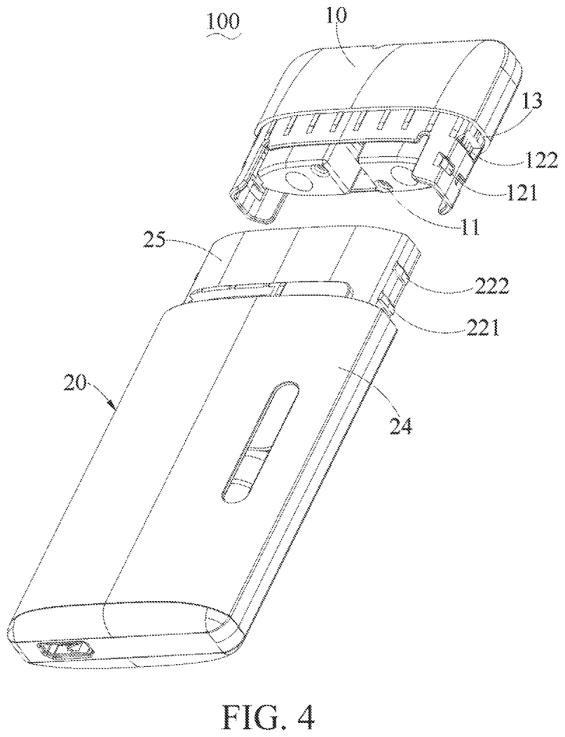

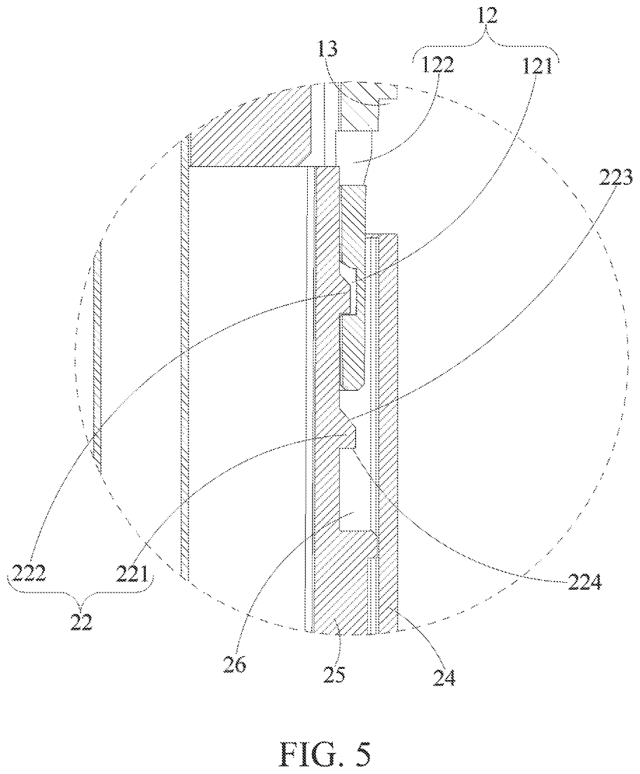

Referring to FIG. 4 and FIG. 5, in some embodiments, the locking portion 22 includes a first locking portion 221 and a second locking portion 222. The first locking portion 221 and the second locking portion 222 are arranged in a length direction of the vaporization device 100. The connection portion 12 includes a first connection portion 121 and a second connection portion 122. The first connection portion 121 and the second connection portion 122 are respectively arranged corresponding to the first locking portion 221 and the second locking portion 222. When the locking portion 22 and the connection portion 12 are in the first state A, the first connection portion 121 is connected to the second locking portion 222; and when the locking portion 22 and the connection portion 12 are in the second state B, the first connection portion 121 is connected to the first locking portion 221, and the second connection portion 122 is connected to the second locking portion 222.

In this way, the first locking portion 221 and the second locking portion 222 are arranged in a vertical direction, and the first connection portion 121 and the second connection portion 122 are also vertically arranged, so that the two connection portions 12 and the two locking portions 22 may be fixedly connected corresponding to each other, and the upper housing 10 and the main body 20 can realize two connection states. When the first connection portion 121 and the second locking portion 222 are connected to realize the first state A, the upper housing 10 and the main body 20 are to be mounted, and the liquid storage tank 21 may be filled with liquid through the liquid injection channel 11. When the first connection portion 121 is connected to the first locking portion 221 and the second connection portion 122 is connected to the second locking portion 222 to realize the second state B, the upper housing 10 and the main body 20 are completely fixed to ensure stability of the fixed connection, and the seal member 23 may block the liquid injection channel 11 to prevent the liquid from leaking out from the liquid storage tank 21 at the same time.

Specifically, the first locking portion 221 and the second locking portion 222 are arranged in a longitudinal direction, and the first connection portion 121 and the second connection portion 122 are also arranged in a longitudinal direction. The upper housing 10 may slide relative to the main body 20 in the longitudinal direction, thereby changing relative positions of the locking portion 22 and the connection portion 12 to switch the state. Meanwhile, a distance between the first locking portion 221 and the second locking portion 222 is equal to a distance between the first connection portion 121 and the second connection portion 122, to ensure that the first connection portion 121 is connected to the first locking portion 221 when switching to the second state B while the second connection portion 122 and the second locking portion 222 may be stably connected.

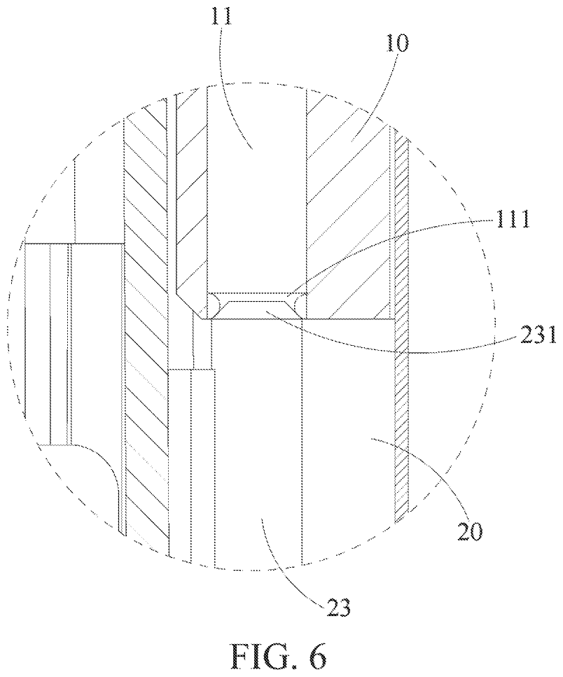

Referring to FIG. 3 and FIG. 6, in some embodiments, when the first connection portion 121 is connected to the second locking portion 222, the liquid injection channel 11 and the seal member 23 are spaced apart from each other, and the liquid injection channel 11 is in communication with the liquid storage tank 21. When the first connection portion 121 is connected to the first locking portion 221 and the second connection portion 122 is connected to the second locking portion 222, the seal member 23 partially extends into the liquid injection channel 11 to block the liquid injection channel 11.

In this way, when the first connection portion 121 and the second locking portion 222 are connected to realize the first state A, the upper housing 10 and the main body 20 are to be mounted, the seal member 23 and the liquid injection channel 11 are spaced apart from each other, and the liquid storage tank 21 may be filled with liquid through the liquid injection channel 11. When the first state A is switched to the second state B, the upper housing 10 and the main body 20 can be close to each other in the vertical direction, so that the first connection portion 121 is connected to the first locking portion 221 and the second connection portion 122 is connected to the second locking portion 222. Meanwhile, the seal member 23 is close to the upper housing 10 together with the main body 20, and the seal member 23 may partially extend into the liquid injection channel 11 to block the liquid injection channel 11.

Referring to FIG. 2 and FIG. 5, in some embodiments, the main body 20 includes a shell 24 and a support 25. The support 25 is arranged inside the shell 24 and connected to the shell 24, and an accommodating groove 26 is formed between the shell 24 and the support 25. The upper housing 10 includes a main body and a connection portion 12 extending from the main body, and the connection portion 12 at least partially extends into the accommodating groove 26 to connect the upper housing 10 and the main body 20.

In this way, the shell 24 can be moved with the support 25 relative to the upper housing 10 at the same time, and the connection portion 12 of the upper housing 10 can extend into the accommodating groove 26, so that the accommodating groove 26 can limit the position of the connection portion 12, avoid dislocation of the connection between the upper housing 10 and the main body 20, and ensure that the connection portion 12 and the locking portion 22 can be stably connected.

Specifically, the support 25 can be formed inside the shell 24, the support 25 can be configured to support a plurality of elements, and the shell 24 and the upper housing 10 cooperate to protect internal components from an external shock and vibration. For example, the support 25 can form the seal member 23, and the seal member 23 can move together with the support 25 and the shell 24, so that the liquid injection channel 11 can be blocked.

Referring to FIG. 5, in some embodiments, the locking portion 22 is formed on the support 25, the locking portion 22 is accommodated in the accommodating groove 26, and the connection portion 12 extends into the accommodating groove 26 to be connected to the locking portion 22.

In this way, during the assembly of the upper housing 10 and the main body 20, the connection portion 12 can be inserted into the accommodating groove 26 to define positions of the upper housing 10 and the main body 20. In this case, the locking portion 22 on the support 25 can cooperate with the connection portion 12, so that the upper housing 10 and the main body 20 realize the first state A and the second state B.

Further, referring to FIG. 2 and FIG. 5, in some embodiments, a limiting groove 13 is formed on the upper housing 10, and the shell 24 abuts against the limiting groove 13 when the locking portion 22 and the connection portion 12 are in the second state.

In this way, the locking portion 22 and the connection portion 12 are in the second state B, the upper housing 10 and the main body 20 are fixedly connected, and the shell 24 may abut against the limiting groove 13 to limit relative positions of the main body 20 and the upper housing 10, so that the shell 24 and the upper housing 10 can cooperate to protect the internal components of the vaporization device 100.

Specifically, during assembly, the upper housing 10 and the main body 20 can be installed together in a form of the first state A, and then the liquid injection operation can be performed through the liquid injection channel 11. After the liquid injection is completed, the upper housing 10 and the main body 20 can be pressed together to realize switch from the first state A to the second state B, so that the vaporization device 100 is fixedly connected. When the locking portion 22 and the connection portion 12 are in the second state B, the shell 24 can abut against the limiting groove 13, thereby limiting the main body 20 and the upper housing 10 to avoid dislocation during assembly.

Referring to FIG. 4 and FIG. 5, in some embodiments, the locking portion 22 includes a protrusion, the connection portion 12 includes a groove, and the protrusion is engaged with the groove to fix the upper housing 10 and the main body 20.

In this way, the protrusions can be engaged with the grooves to fix the relative positions of the upper housing 10 and the main body 20 to ensure that the locking portion 22 and the connection portion 12 can be in the first state A and the second state B.

Specifically, the first locking portion 221 and the second locking portion 222 may be protrusions, and the first connection portion 121 and the second connection portion 122 may also be grooves. The state change of the locking portion 22 and the connection portion 12 is realized by the cooperation of the protrusion and the groove. Certainly, in some embodiments, the locking portion 22 may also be the groove, and the connection portion 12 may be the protrusion.

Referring to FIG. 5, in some embodiments, the protrusion includes an inclined surface 223 and an abutting surface 224. The inclined surface 223 pushes up the upper housing 10 for the protrusion to be engaged with the groove when the upper housing 10 is assembled with the main body 20, and the abutting surface 224 abuts against the groove to prevent the protrusion from being disengaged from the groove.

In this way, during the sliding of the upper housing 10 in a direction close to the main body 20, the upper housing 10 has elasticity, so that the inclined surface 223 can stretch the upper housing 10. After the protrusion enters the groove, the abutting surface 224 can abut against an inner wall of the groove to prevent the upper housing 10 and the main body 20 from moving away, so that the locking portion 22 and the connection portion 12 can realize a fixed connection mode of the first state A and the second state B. In this embodiment, the upper housing 10 and the main body 20 can be close to each other, that is, from the first state A to the second state B, and cannot change from the second state B to the first state A, so as to ensure stability of the vaporization device 100 after assembly.

Referring to FIG. 6, in some embodiments, the seal member 23 is in the shape of a cylinder, the liquid injection channel 11 is in the shape of a circular hole, and the seal member 23 is concentric with the liquid injection channel 11; and when the locking portion 22 and the connection portion 12 are in the second state B, the seal member 23 is in interference fit with the liquid injection channel 11 to block the liquid injection channel 11.

In this way, the seal member 23 is in the shape of a cylinder, the liquid injection channel 11 is in the shape of a circular hole, and the seal member 23 may at least partially extend into the liquid injection channel 11. The seal member 23 is in interference fit with the liquid injection channel 11 to block the liquid injection channel 11, so as to prevent the liquid in the liquid storage tank 21 from leaking through the liquid injection channel 11.

Referring to FIG. 6, in some embodiments, a chamfer 231 is formed at an end of the seal member 23, and a seal ring 111 is formed at an end of the liquid injection channel 11 close to the main body 20; and when the locking portion 22 and the connection portion 12 are in the second state B, the end of the seal member 23 extends into the liquid injection channel 11 and is in interference fit with the seal ring 111 for the seal member 23 to block the liquid injection channel 11.

In this way, when the locking portion 22 and the connection portion 12 are switched to the second state B, the chamfer 231 can conveniently extend into the liquid injection channel 11, and at the same time, an edge and corner of the end of the seal member 23 can be avoided to scratch the seal member 23. The seal ring 111 may be in interference fit with the seal ring 111 to block the liquid injection channel 11 from the inside to prevent the liquid in the liquid storage tank 21 from leaking through the liquid injection channel 11.

In the description of the embodiments of this application, terms “first” and “second” are used merely for the purpose of description, and shall not be construed as indicating or implying relative importance or implying a quantity of indicated technical features. Therefore, a feature defined by “first” or “second” may explicitly indicate or implicitly include one or more such features. In the description of the embodiments of this application, “a plurality of” means two or more, unless otherwise definitely and specifically limited.

In the description of this specification, descriptions using reference terms “an embodiment”, “some embodiments”, “an exemplary embodiment”, “an example”, “a specific example”, or “some examples” mean that specific features, structures, materials, or characteristics described with reference to embodiments or examples are included in at least one embodiment or example of this application. In this specification, exemplary descriptions of the foregoing terms do not necessarily refer to the same embodiment or example. In addition, the described specific features, structures, materials, or characteristics may be combined in a proper manner in any one or more of the embodiments or examples.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporization device, comprising:
an upper housing comprising a liquid injection channel and a connection portion; and
a main body comprising a liquid storage tank configured to store liquid, a locking portion, and a seal member,
wherein the upper housing is sleeved on the main body and configured to fixedly connect the locking portion to the connection portion,
wherein, when the locking portion is fixedly connected to the connection portion and is in a first state, the liquid injection channel is in communication with the liquid storage tank, and
wherein, when the locking portion is fixedly connected to the connection portion and is in a second state, the seal member is configured to block the liquid injection channel.

2. The vaporization device of claim 1, wherein the locking portion comprises a first locking portion and a second locking portion, the first locking portion and the second locking portion are arranged in a length direction of the vaporization device, the connection portion comprising a first connection portion and a second connection portion being respectively arranged corresponding to the first locking portion and the second locking portion,
wherein, when the locking portion and the connection portion are in the first state, the first connection portion is connected to the second locking portion, and
wherein, when the locking portion and the connection portion are in the second state, the first connection portion is connected to the first locking portion, and the second connection portion is connected to the second locking portion.

3. The vaporization device of claim 2, wherein, when the first connection portion is connected to the second locking portion, the liquid injection channel and the seal member are spaced apart from each other, and the liquid injection channel is in communication with the liquid storage tank, and
wherein, when the first connection portion is connected to the first locking portion and the second connection portion is connected to the second locking portion, the seal member partially extends into the liquid injection channel so as to block the liquid injection channel.

4. The vaporization device of claim 1, wherein the main body comprises a shell and a support arranged inside the shell and connected to the shell, and an accommodating groove is formed between the shell and the support, and
wherein the upper housing comprises a main body and a connection portion extending from the main body, the connection portion at least partially extending into the accommodating groove to connect the upper housing to the main body.

5. The vaporization device of claim 4, wherein the locking portion is formed on the support, the locking portion is accommodated in the accommodating groove, and the connection portion extends into the accommodating groove to be connected to the locking portion.

6. The vaporization device of claim 4, wherein a limiting groove is formed on the upper housing, and the shell abuts against the limiting groove when the locking portion and the connection portion are in the second state.

7. The vaporization device of claim 1, wherein the locking portion comprises a protrusion, the connection portion comprises a groove, and the protrusion is engaged with the groove to fix the upper housing and the main body.

8. The vaporization device of claim 7, wherein the protrusion comprises an inclined surface and an abutting surface,
wherein the inclined surface is configured to push up the upper housing for the protrusion to be engaged with the groove when the upper housing is assembled with the main body, and
wherein the abutting surface abuts against the groove to prevent the protrusion from disengaging the groove.

9. The vaporization device of claim 1, wherein the seal member is in a shape of a cylinder, the liquid injection channel is in a shape of a circular hole, and the seal member is concentric with the liquid injection channel, and
wherein, when the locking portion and the connection portion are in the second state, the seal member is in interference fit with the liquid injection channel so as to block the liquid injection channel.

10. The vaporization device of claim 9, wherein a chamfer is formed at an end of the seal member, and a seal ring is formed at an end of the liquid injection channel close to the main body, and
wherein, when the locking portion and the connection portion are in the second state, the end of the seal member extends into the liquid injection channel and is in interference fit with the seal ring for the seal member so as to block the liquid injection channel.
